(19) United States
(12) Patent Application Publication
(10) Pub. No.: US 2026/0276936 A1
(43) Pub. Date: Sep. 17, 2026

(54) CABLE TRAY

(71) Applicant: MELLANOX TECHNOLOGIES, LTD., Yokneam (IL)

(72) Inventors: Dima Denisenko, Afula (IL); Alex Kremenetsky, Kiryat Bialik (IL); Amit Oren, Ramat Hasharon (IL); Moti Cabessa, Ramat Gan (IL)

(21) Appl. No.: 19/080,267

(22) Filed: Mar. 14, 2025

(51) Int. Cl. G02B 6/44

(52) U.S. Cl. CPC G02B 6/4453

(57) ABSTRACT

A cable tray assembly accommodates a plurality of cables therein, particularly for accommodating multiple cables of the same length but that connect connection points that are different distances apart. The cable tray comprises a plurality of cable pathways, wherein each of the plurality of cable pathways route a cable around one or more curves between a first connection point of a plurality of first connection points and a second connection point of a plurality of second connection points; wherein each of the first connection points accommodates one cable and the plurality of first connection points are spaced apart from one another; and wherein each of the plurality of cable pathways accommodate cables having an at least substantially identical length.

### BACKGROUND

As artificial intelligence and/or machine learning use increases, the amount of information being communicated between large clusters of computing resources (e.g., graphical processing units (GPUs), central processing units (CPUs), data processing units (DPUs), and/or the like) is also increasing. Links between computing resources and/or chips thereof are based on copper cables (short reach) or optical cables. In the optical cables, the data to be transferred between chips (or switches) is encoded/decoded from electrical to optical signal (and vice versa) and conveyed via an optical fiber. For optical connections, optical switches encompass computing resources to distribute data packets among a plurality of optical channels to multiple receivers. As the capabilities of those optical switches increases, the number of optical channels supported by each switch also increases. Each of the supported optical channels are connected with corresponding optical fibers that route data packets to connectors that allow users to connect external devices to the optical switches. However, as the number of optical channels supported by each optical switch increases, the manufacturing complexity for a tray including one or more optical switches also increases. For example, each optical channel supported by the optical switch comprises a physically separate connection point for a corresponding optical fiber to connect with the optical switch. For optical switches having computing resources (e.g., switchboards) located within a tray having connectors on a single panel (i.e., a single side of the tray), the connection points of the optical switch are spaced at different distances away from the panel, which can be addressed using different length optical fibers. However, as the number of unique parts increases for an optical switch tray, the manufacturing complexity also increases. Therefore, there is a need in the art for devices that enable the use of a decreased quantity of unique part numbers within a single CPO switch tray to ease the manufacturing process of such a tray.

### GENERAL DESCRIPTION

As the number of optical connections from a computing resource of an optical switch (e.g., a CPO switchboard of a CPO switch) increases, the number of optical fibers connecting to the computing resource likewise increases. Each of these optical fibers connect to a different location on the computing resource (typically around a perimeter of the optical switchboard) and direct signals to/from connectors within an array, typically on a single side of the switch. Consequently, the distance between each connection point on the switch and the connector array varies, so that shorter optical cables could be used for connections on one side of the switch as compared with cables used to connect at optical connection points on an opposite side of the computing resource. However, using unique cables (e.g., different length cables) for various switch connections increases the manufacturing complexity of the switch assembly, at least in part because an assembler must select the proper optical cable from a variety of unique optical cables for each connection. Moreover, optical cables are relatively fragile, making transportation and installation of optical cables within a CPO switch technically challenging to ensure that individual fibers within the optical cables do not break. The disclosure provides the ability to use the same fiber bundle part number for varying connection lengths required within the switch. However, the disclosed trays also enable the use of unique fiber/cable lengths for each connection length. In terms of yield, fiber manufacturing requires a large tolerance in length to allow for rework in case of failures detected during testing. The disclosure allows the use of the same part number and length. It enables the use of a known, tested sub-assembly (a tray with fibers) before system integration, improving yield and reducing assembly and integration time. It also protects the fibers from damage, addressing safety concerns, particularly in cases of high-power laser leakage that could pose a risk to operators. This protection is crucial for maintaining the performance of the optical system. A mechanical device is used to position the fiber ends precisely where needed, regardless of the bundle length. The device routes the fibers while “absorbing” the extra length within itself. In other words, the cable tray has adequate space to accommodate excess length of cable between connection points. This allows the sub-assembly to be tested after routing and before being integrated into the system, eliminating yield impacts caused by assembly mistakes. Prior solutions require the use of cable ties to route fibers inside the system. Additionally, those prior solutions rely on dedicated fiber lengths for each sub-assembly to accommodate varying length requirements. A solution for a safe assembly of the fibers from computing resources of a CPO switchboard to a cable connection point (e.g., the optical mid plane) while using the same length of fibers was needed. The trays of some embodiments are color-coded to prevent mistakes and ensure that fibers are connected correctly.

To ease the transportation process of optical cables and to ease the manufacturing process for a CPO switch, the number of unique part numbers within the CPO switch can be decreased, for example, by using multiple identical cables to connect at different locations on a CPO switch. And these cables can be pre-installed (i.e. pre-routed) in cable tray assemblies that protect against fiber breakage during shipping. Because the connection distance may vary for different connection locations around the perimeter of the CPO switch, a cable tray is provided with defined cable pathways to route between connection points. The cable pathways that accommodate cables with shorter connection distances are more tortuous than the cable pathways that accommodate cables with longer connection distances, so that all cable pathways are at least approximately the same length, regardless of connection distance. However, it should be understood that certain curves or other features defining the tortuous cable pathway can be skipped-so that a cable can be routed around those features, for example, if a cable is sufficiently short that excess cable length does not need to be “absorbed” by the tortuous features of the cable pathway. In this way, the tray can accommodate different cable lengths for a single connection length.

A cable tray for an optical switch as discussed herein enables the use of a single cable type (i.e., a single length) for connecting to multiple sides of a computing resource, and simplifies assembly of the switch with defined cable pathways between connectors on a single side of the switch and attachments on multiple sides of the computing resource. The cable tray defines multiple cable pathways from a connector array on a single side of the cable tray to a computing resource mounted on a printed circuit board (PCB) with a plurality of cable connections. The cable pathways are defined by the cable tray between a connector within the connector array to a PCB connection (which may also be within an array of connections). All of the cable pathways are of substantially equal length, or they enable equal-length cables (e.g., fiber optic cables, but similar trays could be used for any wire, fiber, or cable) to be used for any cable pathway, so that all of the cables routed within the cable tray can be identical. In an example implementation, the cable tray can route cables from the connector array in a single plane of connectors to PCB connections located on a plurality of sides of the PCB (e.g., on all or a plurality of perimeter sides of the PCB). Particularly for fiber optic implementations, the cable pathways are defined by large-radius turns having a radius of curvature greater than a minimum bending radius of fragile fibers. These large-radius curves have a radius of curvature larger than a the minimum bending radius of an optical cable to ensure optical fibers within optical cable do not break while bending around the large-radius curves. These large-radius curves ensure that an installer cannot unintentionally break the optical fibers within the optical cable during installation. Moreover, the cable tray can be provided in multiple parts (e.g., 3 parts) that facilitate assembly of the cable trays with housed cables onto a substrate.

Various embodiments are directed to a cable tray assembly comprising: a plurality of cable pathways, wherein each of the plurality of cable pathways route a cable around one or more curves between a first connection point of a plurality of first connection points and a second connection point of a plurality of second connection points; wherein each of the first connection points accommodates one cable and the plurality of first connection points are spaced apart from one another; and wherein each of the plurality of cable pathways accommodate cables having an at least substantially identical length.

In certain embodiments, each of the plurality of cable pathways comprises a different number of curves. In various embodiments, the plurality of cable pathways define different length cable pathways. In certain embodiments, at least one cable pathway defines at least one loop. In various embodiments, at least one of the plurality of cable pathways accommodates a plurality of cables. In certain embodiments, the plurality of first connection points comprises a first subset of connection points and a second subset of connection points, and wherein the first subset of connection points are arranged perpendicular to the second subset of connection points.

Certain embodiments are directed to a Co-Packaged Optics (CPO) switch comprising: a plurality of computing resources mounted on one or more substrates; a plurality of cable trays according to claim 1, wherein the plurality of cable trays are mounted on the one or more substrates; a plurality of fibers connecting the plurality of computing resources with a plurality of connectors, wherein the plurality of fibers are routed within the plurality of cable pathways of the cable trays and the plurality of fibers have an at least substantially identical length.

In various embodiments, the plurality of connectors are arranged in a planar array. In certain embodiments, the plurality of connectors are offset from the plurality of cable trays. In certain embodiments, the plurality of fibers connect to each of the computing resources at connection points arranged around a perimeter of each of the computing resources. In various embodiments, each of the computing resources is rectangular, and at least one connection point is located on each side of the perimeter of each of the computing resources. In various embodiments, the plurality of fibers are identical.

Certain embodiments are directed to a cable tray comprising: at least one first cable pathway extending between an open first end and a first circuit exit of a plurality of circuit exits; at least one second cable pathway extending between the open first end and a second circuit exit of the plurality of circuit exits, wherein the second circuit exit extends out of the cable tray in a direction different from the first circuit exit; and wherein the first cable pathway and the second cable pathway accommodate cables of at least substantially equal length.

In certain embodiments, the cable tray further comprises a removeable cover. In certain embodiments, the at least one first cable pathway accommodates a plurality of cables. In various embodiments, the second circuit exit is arranged perpendicular to the first circuit exit. In certain embodiments, the at least one first cable pathway is a different length than the at least one second cable pathway. In various embodiments, the at least one first cable pathway defines a different number of curves than the at least one second cable pathway.

Certain embodiments are directed to a cable tray assembly comprising: a first cable tray and a second cable tray; and a third cable tray comprising: a second rigid housing defining at least one third cable pathway extending between a second open end and a third circuit exit of the plurality of circuit exits, wherein all of: (a) the at least one first cable pathway, (b) the at least one second cable pathway, and (c) the at least one third cable pathway accommodate cables of at least substantially equal length; and wherein the first cable tray, the second cable tray, and the third cable tray collectively surround an open center; and wherein the plurality of circuit exits from the first cable tray, the second cable tray, and the third cable tray exit into the open center.

In certain embodiments, the open center is at least substantially rectangular.

### BRIEF DESCRIPTION OF THE SEVERAL VIEWS OF THE DRAWINGS

For a better understanding of embodiments of the disclosure and to show how the same may be carried into effect, reference will now be made, purely by way of example, to the accompanying drawings in which like numerals designate corresponding elements or sections throughout. In the accompanying drawings:

FIG. 1 is an exploded view of a cable tray assembly according to an embodiment;

FIG. 2 is a top view of a cable tray assembly according to an embodiment;

FIG. 3 is an exploded view of a first cable tray of a cable tray assembly according to an embodiment;

FIG. 4 is a top view of a first cable tray of a cable tray assembly according to an embodiment;

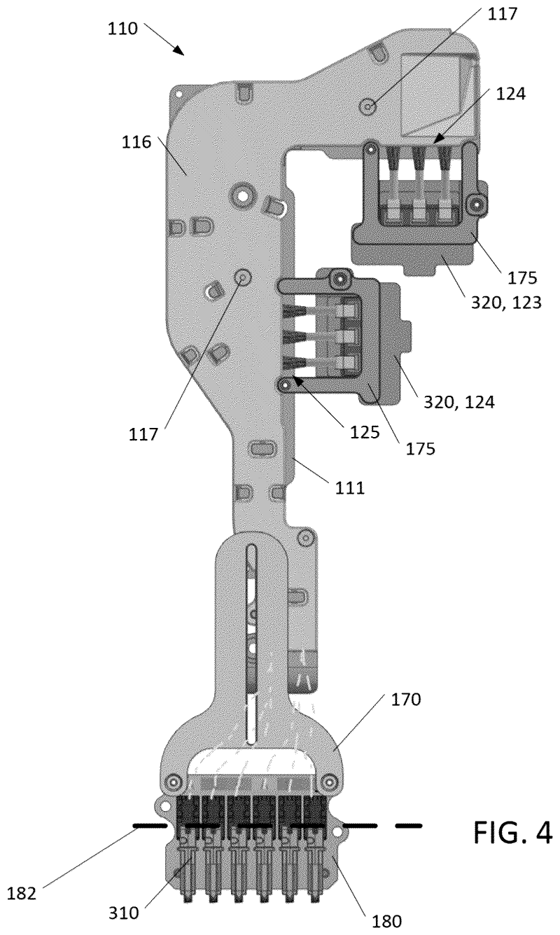

FIG. 5 is a top view of a second cable tray of a cable tray assembly according to an embodiment;

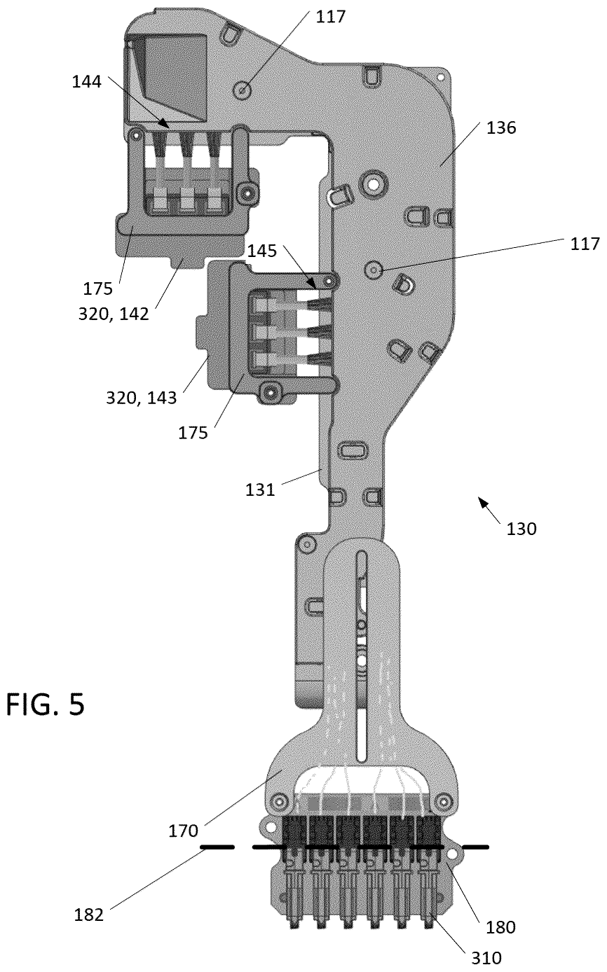

FIG. 6 is a top view of a third cable tray of a cable tray assembly according to an embodiment;

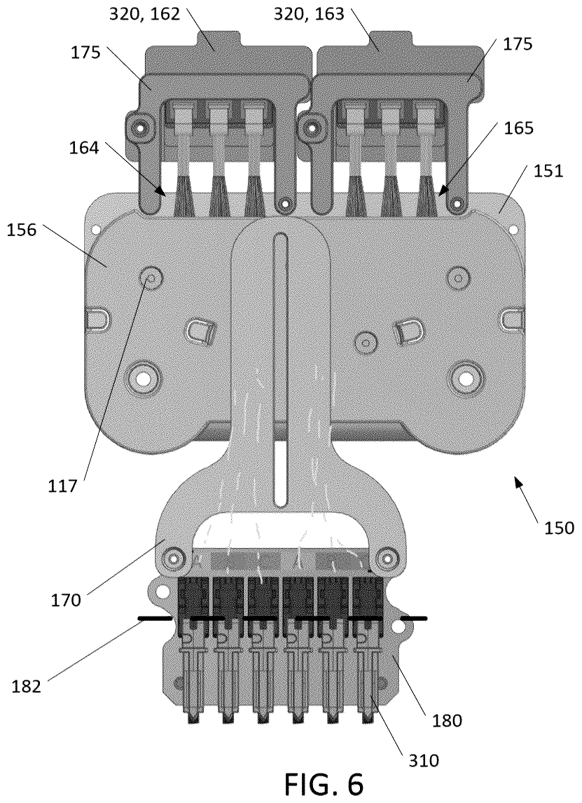

FIG. 7 illustrates example cables according to an embodiment;

FIGS. 8A-8B show a connector support according to an embodiment;

FIG. 9 illustrates cable routing within cable pathways of a cable tray assembly according to an embodiment;

FIG. 10 is a schematic view of a substrate supporting a cable tray assembly and computing resource being assembled into a CPO switch tray according to an embodiment;

FIG. 11 is a top view of a CPO switch tray during assembly according to an embodiment;

FIG. 12 is a top view of a CPO switch tray after assembly of the substrate into the tray, according to an embodiment;

FIG. 13 is a flowchart illustrate assembly steps of a CPO switch tray according to an embodiment;

FIG. 14 illustrates an example computer system that may include electrical components, according to at least one embodiment;

FIG. 15 provides a block diagram that schematically illustrates a computing system that may include one or more electrical components of various embodiments;

FIG. 16 illustrates an example computing environment that may include electrical components, in accordance with at least one embodiment;

FIG. 17 illustrates an example network switch according to at least one embodiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

For cable installations (e.g., fiber optic cable installations) that utilize multiple cables to route signals between a signal controller that includes multiple cable connection points at different spatial locations on the signal controller to a connection panel (or other generally planar array of connectors), each cable may be required to traverse a different connection distance, at least in part because of differences in the spatial positioning of the connection points on the signal controller. However, providing a cable tray that has the capability of minimizing the number of unique cable lengths can ease manufacturing of the cable installation, because installers do not need to sort through cables and find the proper length cable for each cable connection. In other words, a cable tray as discussed herein can accommodate cables having different lengths for different connection distances, but can also accommodate different cable lengths for each of the different connection distances.

To further ease manufacturing of the cable assembly, a cable tray includes a plurality of cable pathways for installing cables. Those cable pathways route cables between installation points. Some of those cable pathways are tortuous paths including a plurality of curves. In some instances, the number of curves in a cable pathway may vary as a function of the connection distance, measured in a straight line between connection points for the cable. By providing more tortuous cable pathways for shorter connection distances, identical cables can be used for cable connections.

As used herein, the term “cable” refers to a flexible wire (e.g., a conductive material, such as copper or aluminum that can be provided in a single strand or multiple strands), collection of wires, a fiber optic strand/fiber, bundle of fiber optic strands/fibers, or other signal carrying apparatus. In many instances, the signal carrying apparatus is covered with a flexible protective sheath along its length. For cables with multiple signal carrying apparatuses (e.g., multi-conductor wires or multi-strand fiber optic cables), the individually sheathed apparatuses may be enclosed within a protective jacket to group the individually sheathed apparatus together into a bundle. As an example, an “optical cable” refers to a cable consisting of one or more optical fibers that are bundled together. The optical cable may provide the optic fibers in any geometric arrangement, including as a ribbon (e.g., with a plurality of optic fibers arranged side-by-side in one or more rows), as a grouped bundle that defines an at least substantially circular cross-section of the optical cable. In some embodiments, the individual fibers within a bundle may be individually sheathed (such that the sheaths of individual fibers are not connected with one another), and the plurality of sheathed fibers may be provided within a single jacket. In some embodiments, the jacket and sheath may be integrated, such as for a ribbon cable in which the integrated jacket and sheath serve to sheath individual fibers and to maintain a desired flat arrangement of the fibers relative to one another. The jacket and sheaths can be flexible, so that the resulting optical cable is flexible. As an example, the jacket and sheaths may be flexible polymers. However, it should be understood that other jacket and sheath configurations may be utilized.

Silicon Photonics (SiP) is a technology that enables optical systems to be manufactured using silicon processes with silicon as the optical medium. Various optical components, such as interconnects and signal processing components, may be fabricated and integrated in a single SiP device. Some SiP devices are fabricated on a silica substrate or over a silica layer on a silicon substrate, a technology that is often referred to as Silicon on Insulator (SOI). In certain optical systems, a SiP device is attached to an external device to facilitate optical communications. However, it is generally difficult to accurately align light signals on the SiP with an external device that receives the light. In certain optical systems, a SiP device is attached to an external device to facilitate optical communications. However, it is generally difficult to accurately align light signals on the SiP with an external device that receives the light. For instance, long range transmission of light signals is generally performed within optical fibers. When optical signals are generated or processed in a SiP device for transmission over optical fibers, the light needs to be coupled between the SiP device and the optical fibers. This coupling between the SiP device and the optical fibers is generally difficult because waveguides within the SiP device generally have a smaller diameter than the optical fibers. As such, a “world-to-chip” interface problem often arises in SiP technologies where coupling of light between Si wire waveguides and optical fibers, and vice versa, is generally inefficient.

“Co-packaging” may refer to the close integration of different electrical and/or optoelectronic chips in the same package.

### Cable Tray

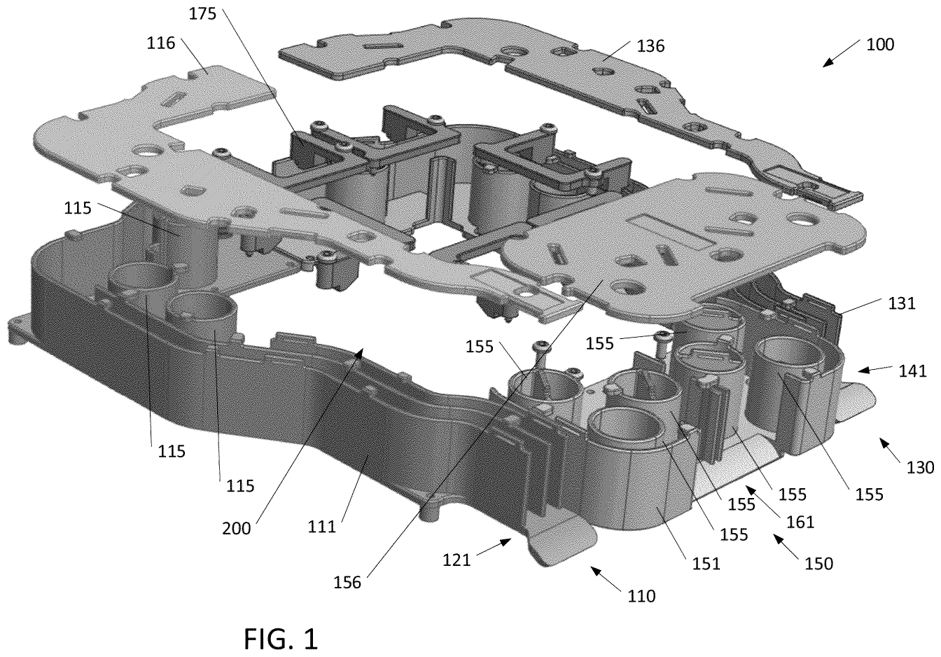

FIG. 1 shows an exploded view of a cable tray assembly 100 according to one embodiment. The cable tray assembly 100 comprises multiple cable trays 110, 130, 150 that can be easily aligned and secured to a substrate adjacent to a computing resource (e.g., an ASIC). Collectively, the multiple cable trays of the cable tray assembly 100 can at least partially surround the computing resource, such that cables routed through the cable tray assembly can attach to multiple sides of the computing resource.

As specifically shown in FIG. 1, the cable tray assembly 100 comprises a first cable tray 110, a second cable tray 130, and a third cable tray 150. In the illustrated embodiment, the fist cable tray 110 is a mirror image of the second cable tray 130, such that both the first cable tray 110 and second cable tray 130 have the same features, but the positioning of these features are reversed relative to one another. As discussed in greater detail for each of the cable trays individually, each cable tray defines one or more cable pathways for routing cables from an open first end 121, 141, 161 of the cable tray to one or more connection points accessible from the interior of the cable tray through circuit exits 124, 125, 144, 145, 164, 165 positioned adjacent the one or more connection points on a computing resource. When installed on a substrate, the open first end 121, 141, 161 of all of cable trays in the cable tray assembly 100 are at least substantially aligned within a single plane, however the connection points vary in placement and distance from the plane of the open first ends 121, 141, 161 of the cable trays. Cables installed in the cable trays connect with connectors that are in a planar array of connectors 182 that may be spaced a distance away from the open first end of the cable trays. Consequently, the connection distances, measured between the connection points and the connector plane vary for each connection point. However, the cable pathways of each cable tray include curves (e.g., large-radius curves) to accommodate cables that are longer than the connection distances. These large-radius curves have a radius of curvature larger than a the minimum bending radius of an optical cable to ensure optical fibers within optical cable do not break while bending around the large-radius curves. These large-radius curves ensure that an installer cannot unintentionally break the optical fibers within the optical cable during installation. Thus, the cable tray can utilize multiple cables of the same length, regardless of the connection distance. In the illustrated embodiments, the large-radius curves are spaced such that a cable can be routed between these large-radius curves to thereby skip those curves, for example, if a cable is sufficiently short that excess length does not need to be absorbed by the large radius curves and instead the cable can directly route between connection points.

Lastly, as shown in FIG. 1, the cable trays may each comprise a cover to enclose and protect cables routed through the respective cable pathways. The covers of each cable tray may be attached with snap-in or slide-in clips and/or the covers can be secured in place with fasteners (e.g., screws).

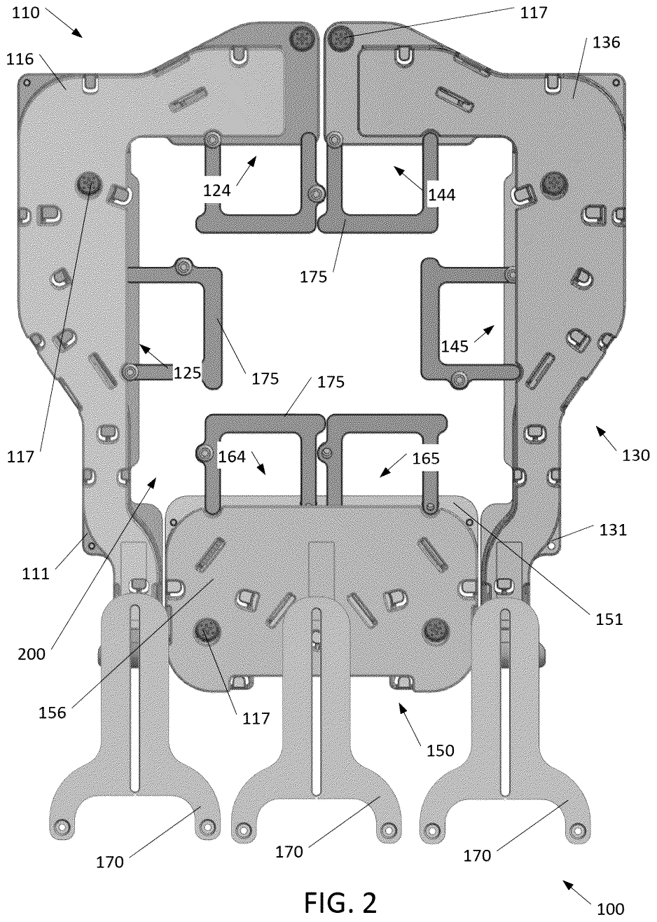

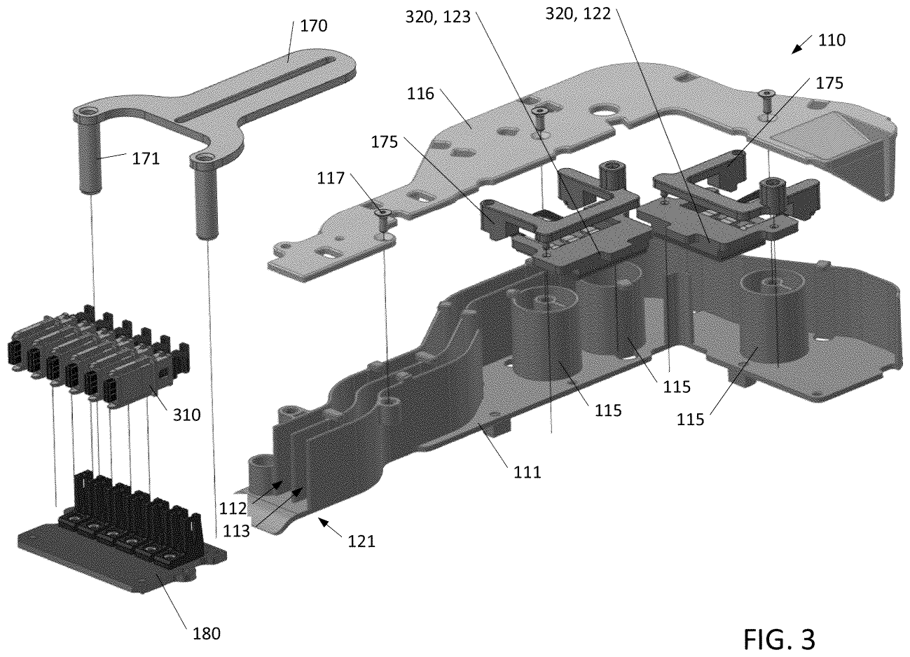

FIG. 2 is a top view of the cable tray assembly 100, additionally including connector stand-offs 170 that connect with connector supports (e.g., during installation of the cable trays onto a substrate). The connector supports maintain connectors aligned in the connector plane, which may be spaced a distance away from the open first ends 121, 141, 161 of the cable trays. The connector stand-offs 170 (visible in FIG. 3) may include offset posts to offset the connector supports relative to the open first ends 121, 141, 161.

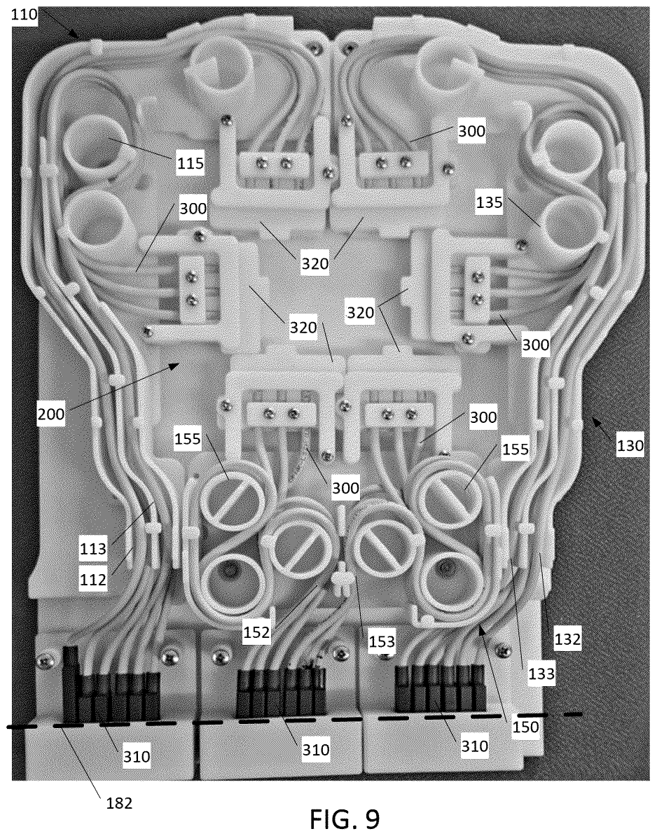

FIG. 3 shows an exploded view of a first cable tray 110 according to one embodiment. The first cable tray 110 includes a first tray body 111 that defines one or more cable pathways. In the illustrated embodiment, the tray body 111 defines a first cable pathway 112 and a second cable pathway 113. FIG. 9 shows the cable routing for each of the first cable pathway 112 and second cable pathway 113. As shown, the first cable tray 110 is generally “L” shaped, such that the first cable tray 110 is positioned adjacent to at least two perpendicular sides of a computing resource when installed. In use, the first cable tray 110 supports cables that connect on each of the two perpendicular sides of the computing resource. The first cable pathway 112 accommodates one or more cables extending from a connector plane through a first circuit exit 124 to a first connection point 122 (e.g., connected with an input/output (I/O) port of a computing resource, and the second cable pathway 113 accommodates one or more cables extending from the connector plane through a second circuit exit 125 to a second connection point 123 (e.g., connected with an I/O port of a computing resource). In the illustrated embodiment, the first connection point 122 is positioned perpendicular to the second connection point 123 (to connect onto perpendicular sides of the computing resource). However, it should be understood that other configurations are possible, for example, to provide connections with other shapes of computing resources. As shown, the first connection point 122 has a greater connection distance to the connection plane than the second connection point 123. However, the second cable pathway 113 includes curves defined in part by a plurality of routing tubes 115, such that cables of equal distance can be routed through the connection pathways 112, 113 to connect on opposite ends of the cables-at the connector plane and at connection points 122, 123.

The first cable tray 110 further comprises a first cover 116 that can be attached to an open top side of the first tray body 111 (e.g., using one or more clips and/or fasteners 117). The first cover 116 encloses each of the first cable pathway 112 and second cable pathway 113 to protect and enclose cables in each of the cable pathways 112, 113 such that the cables cannot move out of the respective cable pathways when installed.

As shown in FIG. 3, a connector stand-off 170 can be secured (e.g., temporarily) to the first cover 116 and first tray body 111. The connector stand-off 170 can be secured (e.g., temporarily) to a connector support 180 that has a plurality of connectors 310 secured thereto. The connector stand-off 170 rigidly secures the connector support 180 (and connectors 310) relative to the first cable tray 110 to enable the first cable tray 110 to be transported with cables installed therein (including connectors 310), without being rigidly secured onto a substrate (e.g., within a CPO switch). As shown, the connector stand-off 170 includes offset posts 171 such that the connector support 180 need not be secured planar to the first tray body 111. In use, the offset posts 171 may be provided to ease installation of the first cable tray 110 in a desired configuration (e.g., within a CPO switch). For example, in a CPO switch in which the connector supports 180 are secured to a surface that is offset to the substrate that supports the first tray body 111, the offset posts 171 are configured to enable an assembler to (a) secure the first tray body 111 (including cables that extend to connectors on the connector support) onto the supporting substrate and (b) secure the connector support onto a supporting surface before removing the connector stand-off 170. In this way, the cables installed in the first cable tray 110 are not undesirably bent or stressed during the installation process.

Similarly, the first cable tray 110 includes one or more brackets 175 usable to secure (e.g., temporarily) compute connectors 320 at each of the first connection point 122 and second connection point 123. Like the connector stand-off 170, the brackets ensure that the compute connectors 320 are rigidly secured to the first cable tray 110 during transport with cables installed therein. The brackets 175 position the compute connectors 320 at the first connection point 122 and second connection point 123, such that those compute connectors 320 can be secured to a computing resource mounted to the supporting substrate when mounting the first cable tray 110 onto the supporting substrate, but before removing the brackets 175. In short, the brackets 175 and connector stand-off 170 ensure that the connectors 310 and compute connectors 320 that are securely attached to cables in the first cable tray 110 are not allowed to dangle unsupported when moving the first cable tray 110. The brackets 175 and connector stand-off 170 can be removed after all of the first cable tray 110, connector support 180, and compute connectors 320 are rigidly installed, for example, in a CPO switch.

The second cable tray 130 has a mirrored configuration as compared with the first cable tray 110. The second cable tray 130 includes a second tray body 131 that defines one or more cable pathways. In the illustrated embodiment, the tray body 131 defines a first cable pathway 132 and a second cable pathway 133. FIG. 9 shows the cable routing for each of the first cable pathway 132 and second cable pathway 133. As shown, the second cable tray 130 is generally “L” shaped, such that the second cable tray 130 is positioned adjacent to at least two perpendicular sides of a computing resource when installed. In use, the second cable tray 130 supports cables that connect on each of the two perpendicular sides of the computing resource. The first cable pathway 132 accommodates one or more cables extending from a connector plane through a first circuit exit 144 to a first connection point 142 (e.g., connected with an I/O port of a computing resource), and the second cable pathway 133 accommodates one or more cables extending from the connector plane through a second circuit exit 145 to a second connection point 143 (e.g., connected with an I/O port of a computing resource). In the illustrated embodiment, the first connection point 142 is positioned perpendicular to the second connection point 143 (to connect onto perpendicular sides of the computing resource). However, it should be understood that other configurations are possible, for example, to provide connections with other shapes of computing resources. As shown, the first connection point 142 has a greater connection distance to the connection plane than the second connection point 143. However, the second cable pathway 133 includes curves at least partially around a plurality of routing tubes 135, such that cables of equal length can be routed through the connection pathways 132, 133 to connect on opposite ends of the cables-at the connector plane and at connection points 142, 143. As discussed herein, the routing tubes 135 may be positioned such that a cable can be routed to skip the curves defined by the routing tubes 135, for example, if the cable is sufficiently short that excess cable length need not be absorbed by the routing tubes 135. For the sake of clarity, because the first cable tray 110 and second cable tray 130 are mirrored, it should be understood that the first cable pathway and second cable pathway 112, 113 of the first cable tray 110, and the first cable pathway and second cable pathway 132, 133 of the second cable tray 130 all accommodate cables having the same length. Moreover, as shown in FIG. 2, the mirrored “L” shapes of the first cable tray 110 and second cable tray 130 partially define an open center 200 between the first cable tray 110 and second cable tray 130. When the cable tray assembly 100 is installed on a substrate, the open center 200 is a portion of the substrate that is not occupied by the cable tray assembly 100, and is surrounded by the cable tray assembly 100. In practice, the open center 200 is sized to accommodate a computing resource mounted on the substrate, so that the cable tray assembly 100 surrounds the computing resource and cables/fibers routed through the trays 110, 130, 150 are routed to connect to the computing resource on multiple sides thereof. A computing resource can be positioned in the open center 200, so that the first cable tray 110 and second cable tray 130 partially surround the computing resource. Moreover, the mirrored “L” shapes of the first cable tray 110 and second cable tray 130 position the connection points 122 and 142 on opposite sides of the open center 200 and perpendicular to the first open end 121, 141 of the trays 110, 130. Moreover, the mirrored “L” shapes of the first cable tray 110 and second cable tray 130 position the connection points 142 and 143 adjacent one another, on the same side of the open center and generally parallel to the first open end 121, 141 of the trays 110, 130.

The second cable tray 130 further comprises a second cover 136 that can be attached to an open top side of the second tray body 131 (e.g., using one or more clips and/or fasteners 117). The second cover 136 encloses each of the first cable pathway 132 and second cable pathway 133 to protect and enclose cables in each of the cable pathways 132, 133 such that the cables cannot move out of the respective cable pathways when installed.

As shown in FIG. 2, a connector stand-off 170 can be secured (e.g., temporarily) to the second cover 136 and second tray body 131. As discussed with respect to the first cable tray 110, the connector stand-off 170 can be secured (e.g., temporarily) to a connector support 180 that has a plurality of connectors 310 secured thereto. The connector stand-off 170 rigidly secures the connector support 180 (and connectors 310) relative to the second cable tray 130 to enable the second cable tray 130 to be transported with cables installed therein (including connectors 310), without being rigidly secured onto a substrate (e.g., within a CPO switch). As shown, the connector stand-off 170 includes offset posts 171 such that the connector support 180 need not be secured planar to the second tray body 131. In use, the offset posts 171 may be provided to ease installation of the second cable tray 130 in a desired configuration (e.g., within a CPO switch). For example, in a CPO switch in which the connector supports 180 are secured to a surface that is offset to the substrate that supports the first tray body 111, the offset posts 171 are configured to enable an assembler to (a) secure the first tray body 111 (including cables that extend to connectors on the connector support) onto the supporting substrate and (b) secure the connector support onto a supporting surface before removing the connector stand-off 170. In this way, the cables installed in the first cable tray 110 are not undesirably bent or stressed during the installation process.

Similarly, the second cable tray 130 includes one or more brackets 175 usable to secure (e.g., temporarily) compute connectors 320 at each of the first connection point 142 and second connection point 143. Like the connector stand-off 170, the brackets 175 ensure that the compute connectors 320 are rigidly secured to the second cable tray 130 during transport with cables installed therein. The brackets 175 position the compute connectors 320 at the first connection point 142 and second connection point 143, such that those compute connectors 320 can be secured to a computing resource mounted to the supporting substrate when mounting the second cable tray 130 onto the supporting substrate, but before removing the brackets 175. In short, the brackets 175 and connector stand-off 170 ensure that the connectors 310 and compute connectors 320 that are securely attached to cables in the second cable tray 130 are not allowed to dangle unsupported when moving the second cable tray 130. The brackets 175 and connector stand-off 170 can be removed after all of the second cable tray 130, connector support 180, and compute connectors 320 are rigidly installed, for example, in a CPO switch.

The third cable tray 150 includes analogous components as the first cable tray 110 and second cable tray 130. However, the third cable tray 150 has a different overall shape than the first cable tray 110 and second cable tray 130. As shown, the third cable tray 150 directs cables between the first open end 161 and connection points located on an opposite side of the third cable tray 150 as the first open end 161. When all of the cable trays 110, 130, and 150 of the cable tray assembly 100 are installed together, the cable trays define an entire perimeter surrounding the open center 200 and cables can connect on all sides of a square/rectangular computing resource positioned in the open center 200.

The third cable tray 150 includes a third tray body 151 that defines one or more cable pathways. In the illustrated embodiment, the third tray body 151 defines a first cable pathway 152 and a second cable pathway 153. FIG. 9 shows the cable routing for each of the first cable pathway 152 and second cable pathway 153. As shown, the third cable tray 150 is generally rectangular such that the third cable tray 150 is positioned adjacent to one side of a computing resource when installed- and more specifically positioned between the computing resource and the first open side of the cable tray assembly 100. In use, the third cable tray 150 supports cables that connect on one side of the computing resource. The first cable pathway 153 accommodates one or more cables extending from the connector plan through a first circuit exit 164 to a first connection point 162 (e.g., connected with an I/O port of a computing resource), and the second cable pathway 153 accommodates one or more cables extending from the connector plane through a second circuit exit 165 to a second connection point 163 (e.g., connected with an I/O port of a computing resource). In the illustrated embodiment, the first connection point 162 is adjacent and planar with the second connection point 163. However, it should be understood that other configurations are possible, for example, to provide connections with other shapes of computing resources. As shown, the first connection point 162 and second connection point 163 have identical connection distances measured to the connection plane. However, the first connection point 162 and second connection point 163 of the third cable tray 150 have shorter connection distances than any of the connection points 122, 123, 142, 143 of the first cable tray 110 and second cable tray 130. Accordingly, each of the first cable pathway 153 and second cable pathway 154 include curves defined in part by a plurality of routing tubes 155 such that cables of equal length can be routed through connection pathways 152, 153 and the connection pathways 112, 113, 132, 133. As shown in FIG. 9, the cable pathways 152, 153 extend multiple times around at least one routing tube 155 such that the cable pathways 152, 153 accommodate a cable length longer than the connection distances for the connection points 162, 163. However, it should be understood that shorter cables may skip one or more curves around routing tubes 155, as those cables do not need excess length to be absorbed within the tray 150 for extending between connection points.

Like the first cable tray 110 and the second cable tray 130, the third cable tray 150 comprises a third cover 156 that can be attached to an open top side of the third tray body 151 (e.g., using one or more clips and/or fasteners 117). The third cover 156 encloses each of the first cable pathway 152 and second cable pathway 153 to protect and enclose cables in each of the cable pathways 152, 153 such that the cables cannot move out of the respective cable pathways when installed.

As shown in FIG. 2, a connector stand-off 170 can be secured (e.g., temporarily) to the third cover 156 and third tray body 151. As discussed with respect to the first cable tray 110, the connector stand-off 170 can be secured (e.g., temporarily) to a connector support 180 that has a plurality of connectors 310 secured thereto. The connector stand-off 170 rigidly secures the connector support 180 (and connectors 310) relative to the third cable tray 150 to enable the third cable tray 150 to be transported with cables installed therein (including connectors 310), without being rigidly secured onto a substrate (e.g., within a CPO switch). As shown, the connector stand-off 170 includes offset posts 171 such that the connector support 180 need not be secured planar to the third tray body 151. In use, the offset posts 171 may be provided to ease installation of the third cable tray 150 in a desired configuration (e.g., within a CPO switch). For example, in a CPO switch in which the connector supports 180 are secured to a surface that is offset to the substrate that supports the third tray body 151, the offset posts 171 are configured to enable an assembler to (a) secure the third tray body 151 (including cables that extend to connectors on the connector support) onto the supporting substrate and (b) secure the connector support onto a supporting surface before removing the connector stand-off 170. In this way, the cables installed in the third cable tray 150 are not undesirably bent or stressed during the installation process.

Similarly, the third cable tray 150 includes one or more brackets 175 usable to secure (e.g., temporarily) compute connectors 320 at each of the first connection point 162 and second connection point 163. Like the connector stand-off 170, the brackets 175 ensure that the compute connectors 320 are rigidly secured to the third cable tray 150 during transport with cables installed therein. The brackets 175 position the compute connectors 320 at the first connection point 162 and second connection point 163, such that those compute connectors 320 can be secured to a computing resource mounted to the supporting substrate when mounting the third cable tray 150 onto the supporting substrate, but before removing the brackets 175. In short, the brackets 175 and connector stand-off 170 ensure that the connectors 310 and compute connectors 320 that are securely attached to cables in the third cable tray 150 are not allowed to dangle unsupported when moving the third cable tray 150. The brackets 175 and connector stand-off 170 can be removed after all of the third cable tray 150, connector support 180, and compute connectors 320 are rigidly installed, for example, in a CPO switch.

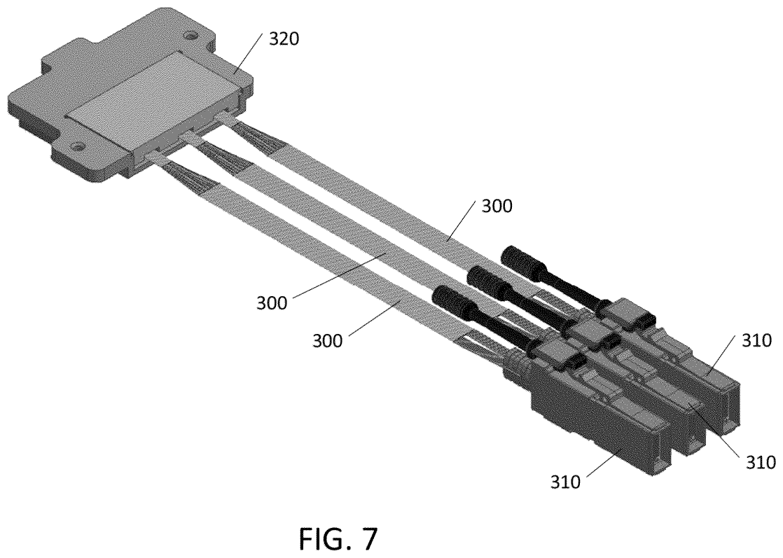

FIG. 7 shows example cables 300 with connectors 310 on a first end, and connections to compute connectors 320 on an opposite second end. The cables 300 illustrated in FIG. 7 are provided in groups of 3 cables 300 for connection to a single compute connector 320. Accordingly, all 3 of the illustrated cables 300 would be routed through a single cable pathway extending from the compute connector 320 (located at a connection point) to the connectors 310 mounted on a connector support 180.

The compute connectors 320, when secured to computing resources 450, define a first connection point for respective cables 300 routed through the cable trays. The first connection points are spaced apart from one another based on the spacing and positioning of the compute connectors 320. In the illustrated examples, the first connection points may be divided into subsets of first connection points (each subset of first connection points being on a separate compute connector 320), and at least some of those subsets of first connection points may be arranged perpendicular to one another.

The connectors 310, when secured onto the connector support 180, define a second connection point for respective cables 300 routed through the cable trays (the second connection points are spaced apart from one another based on the spacing of the connectors 310).

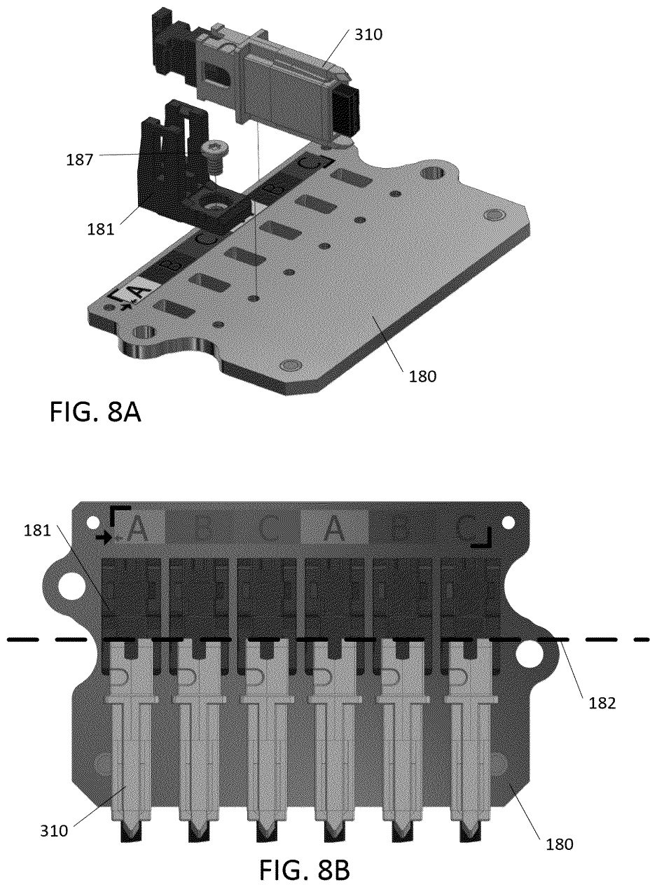

FIGS. 8A-8B show an example connector support 180 with connectors 310 attached thereto. As shown, the connectors 310 may be secured to the connector support 180 using a snap feature 181 fastened to the connector support 180 with a fastener 187. However, it should be understood that the connectors 310 may be secured to the connector support 180 using any of a variety of fastening mechanisms.

FIG. 9 shows example routing of cables 300 within the cable tray assembly 100 of one embodiment. As shown, each of the cable pathways 112, 113, 132, 133, 152, 153 all contain a 3-cable 300 assembly (similar to that shown in FIG. 7). All of the cables 300 shown in FIG. 9 have an identical length. Any excess length of cable (e.g., for routing through cable pathways 113, 133, 152, 153) is accommodated by routing the cables 300 through a tortuous cable pathway around curved defined in part by routing tubes 115, 135, 155 (one or more times, such as defining a loop around at least one routing tube). The routing tubes 115, 135, 155 have a diameter sufficiently large to provide a safe bending radius for the cables. Particularly for optical cables, the cables are at risk of breakage if bent at around a sharp corner. The routing tubes 115, 135, 155 define a bending radius for a cable bent around the routing tubes that is greater than a minimum bending radius to prevent breakage of fibers within the cables, to prevent installers from unintentionally breaking optical fibers within cables when installing the cables in the tray. Accordingly, the cables 300 bent around curved defined by the routing tubes 115, 135, 155 maintain functionality for transmitting signals (e.g., optical signals).

It should be understood that the cable tray assembly of FIG. 9 can also accommodate cables of different length for different connection distances. For example, shorter cables can be used for shorter connection distances. Those shorter cables can skip the curves defined around the one or more routing tubes 115, 135, 155 to more directly connect between connection points.

### Co-Packaged Optic (CPO) Switch

A cable tray assembly 100 as discussed herein may be provided as a part of a computer system 400 (e.g., a CPO switch). In example embodiments, the cable tray assembly 100 is provided to protect cables 300 for routing signals from a computing resource 450 on a substrate 451 to the plurality of connectors 380 for connection to additional devices.

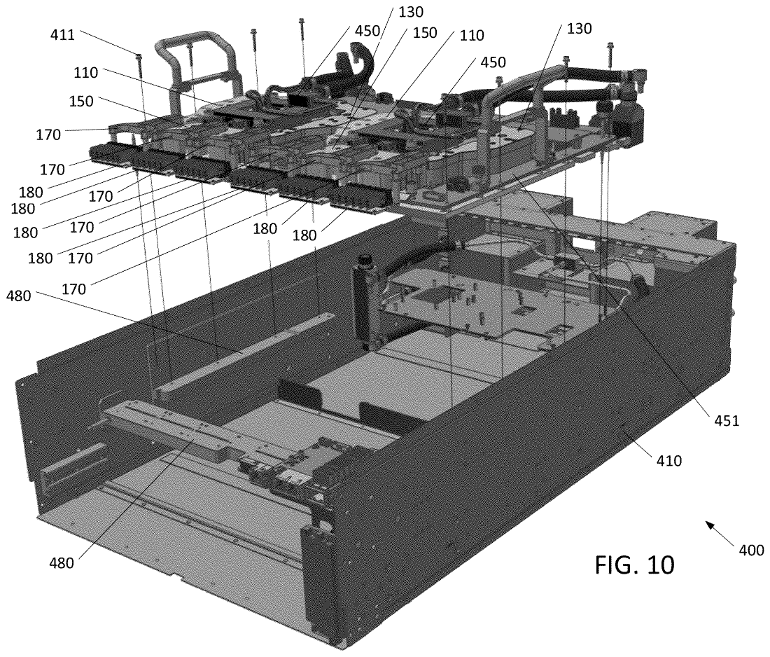

FIGS. 10-12 illustrate an example computer system 400 (e.g., a CPO switch) according to one embodiment. FIG. 10 shows a substrate 451 supporting a plurality of computing resources 450 each surrounded by a cable tray assembly 100 as discussed herein. As shown in FIG. 10, the substrate 451 is being installed and secured in a tray housing 410 of the computer system 400 (e.g., a CPO switch), with the computing resources 450, cable tray assemblies 100, and other components mounted onto the substrate 451. Although not shown, the computing resources 450 and cable tray assemblies 100 can be mounted onto the substrate using one or more placement jigs to ensure proper placement of these components during installation. Moreover, although not shown in FIG. 10, the cable tray assemblies 100 can include cables 300 pre-installed therein. Accordingly, the connectors 310 are supported on the connector supports 180, which are supported from the substrate-mounted cable tray assemblies 100 using connector standoffs 170 as shown in FIG. 10. Moreover, the compute connectors 320 are also temporarily supported on the cable tray assemblies 100 during installation. The compute connectors 320 are supported by brackets 175 that maintain proper alignment of the compute connectors 320 relative to the computing resources 450 (with proper alignment of the cable tray assembly 100 using a jig) to facilitate connection of the compute connectors 320 relative to the computing resources 450.

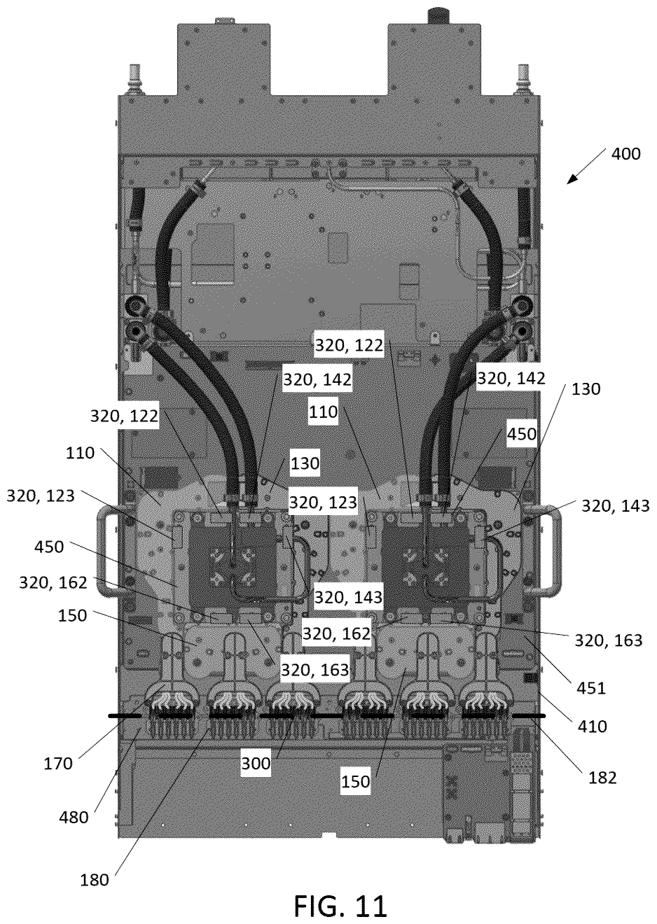

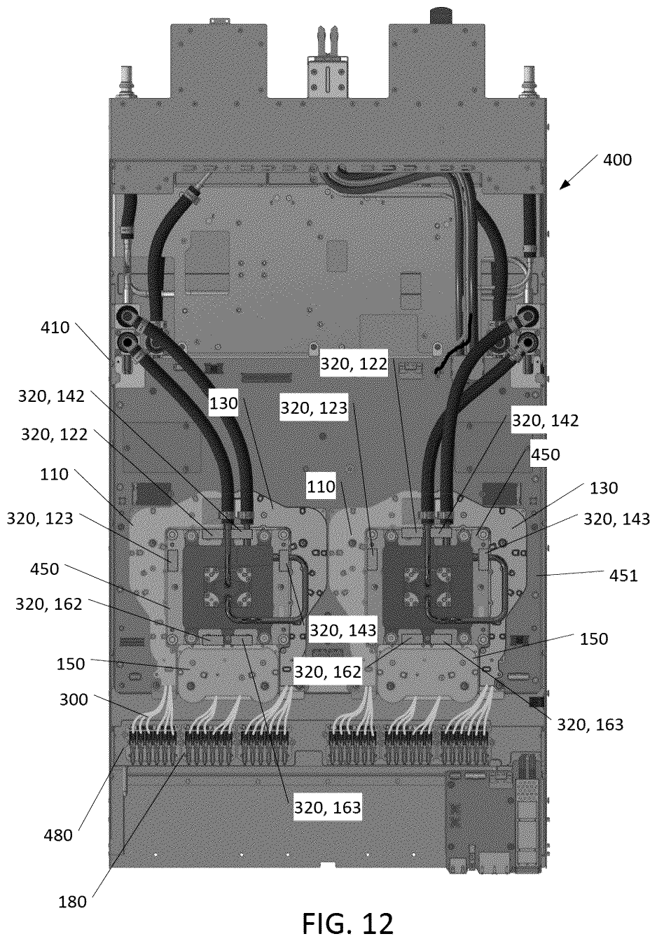

When installed, as shown in FIG. 11, the substrates are supported on, and secured to, substrate supports 480 secured to interior sidewalls of a tray housing 410. The connector supports are supported on, and secured to, a support bar 480. In certain embodiments, the support bar 480 may be offset relative to the substrate supports 480. In other embodiments, the substrate supports 480 are at least substantially co-planar with the support bar 480. Once the substrate 451 and connector supports 180 are secured into the tray housing 410, and the compute connectors 320 are secured to the computing resources 450, the connector stand-offs 170 and brackets 175 can be removed, as shown in FIG. 12.

The connectors 310 can be connected with external connections (e.g., in a shuffle box), and a front cover of the CPO switch can be secured to enclose the housing. The computer system 400 (e.g., CPO switch) can be connected within a server rack that provides power and network connectivity with compute trays and/or other CPO switches within a data center.

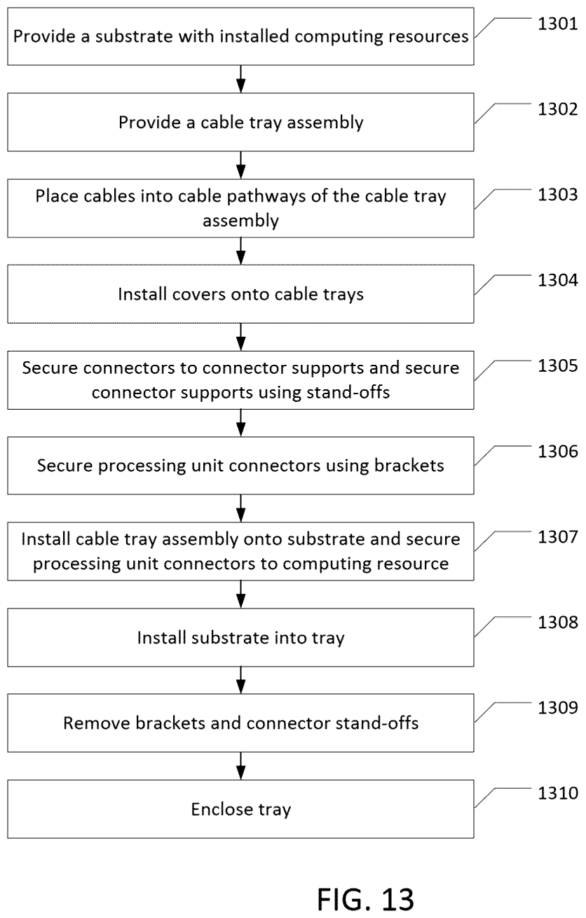

FIG. 13 illustrates an example CPO switch construction method according to certain embodiments.

As shown in block 1301, a substrate having computing resources installed thereon is provided.

At block 1302, a cable tray assembly is provided, and at block 1303, a plurality of cables are placed into cable pathways within the cable tray assembly. The cables may be of equal length, and the cable pathways define tortuous paths as discussed herein for at least some of the cables, to accommodate different connection lengths between desired connection locations on opposite ends of the cables.

At block 1304, covers are installed on the cable tray assemblies to enclose the cables within the cable pathways.

At block 1305, connectors 310 are secured to connector supports 180, and those connector supports are secured to the cable tray assemblies by connector stand-off 170.

At block 1306, compute connectors 320 are secured to the cable tray assemblies by brackets 175.

At block 1307, the cable tray assemblies are installed on the substrate, surrounding the one or more computing resources (e.g., using an alignment jig). The cable tray assemblies comprise multiple cable trays, and each cable tray may be installed independently of the other cable trays, until all cable trays of the cable tray assembly are installed.

At block 1308, the substrate 451 can be installed into a tray housing 410.

At block 1309, the brackets 175 and connector stand-offs 170 are removed, after the connector supports 180 are secured within the tray housing 410, and after the compute connectors 320 are secured to the computing resources 450.

At block 1310, the tray house 410 is enclosed with a front cover having one or more connections and/or with a top cover (not shown).

### Example Systems Including Cable Tray Assemblies

In various embodiments, cable tray assemblies 100 are incorporated into various systems. For example, various cable tray assemblies 100 may be incorporated into datacenters, CPO switches, processing units, ICs, systems on and/or including PCBs, optical interconnects, and/or the like. Some example systems that may cable tray assemblies 100 of various embodiments are now described.

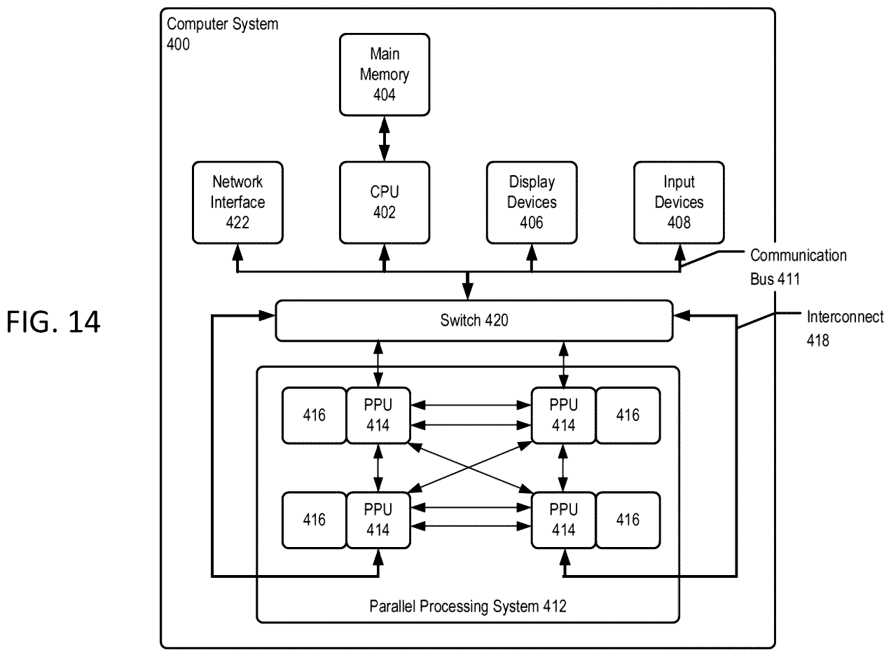

FIG. 14 illustrates a computer system 400, according to at least one embodiment. In at least one embodiment, computer system 400 is configured to implement various processes and methods described throughout this disclosure.

In at least one embodiment, computer system 400 comprises, without limitation, at least one computing resource embodied as a central processing unit (“CPU”) 402 that is connected to a communication bus 411 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 400 includes, without limitation, a main memory 404 and control logic (e.g., implemented as hardware, software, or a combination thereof) and data are stored in main memory 404 which may take form of random access memory (“RAM”). In at least one embodiment, a network interface subsystem (“network interface”) 422 provides an interface to other computing devices and networks for receiving data from and transmitting data to other systems from computer system 400.

In at least one embodiment, computer system 400, in at least one embodiment, includes, without limitation, input devices 408, parallel processing system 412, and display devices 406 which can be implemented using a conventional cathode ray tube (“CRT”), liquid crystal display (“LCD”), light emitting diode (“LED”), plasma display, or other suitable display technologies. In at least one embodiment, user input is received from input devices 408 such as keyboard, mouse, touchpad, microphone, and more. In at least one embodiment, each of foregoing modules can be situated on a single semiconductor platform to form a processing system.

In at least one embodiment, computer programs in form of machine-readable executable code or computer control logic algorithms are stored in main memory 404 and/or secondary storage. Computer programs, if executed by one or more processors, enable system 400 to perform various functions in accordance with at least one embodiment. memory 404, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 402; parallel processing system 412; an integrated circuit capable of at least a portion of capabilities of both CPU 402; parallel processing system 412; a chipset (e.g., a group of integrated circuits designed to work and sold as a unit for performing related functions, etc.); and any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 400 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 412 includes, without limitation, a plurality of computing resources embodied as parallel processing units (“PPUs”) 414 and associated memories 416. In at least one embodiment, PPUs 414 are connected to a host processor or other peripheral devices via an interconnect 418 and a switch 420 or multiplexer. In at least one embodiment, parallel processing system 412 distributes computational tasks across PPUs 414 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 414, although such shared memory may incur performance penalties relative to use of local memory and registers resident to a PPU 414. In at least one embodiment, operation of PPUs 414 is synchronized through use of a command such as_syncthreads( ), wherein all threads in a block (e.g., executed across multiple PPUs 414) to reach a certain point of execution of code before proceeding.

The switches within each layer (e.g., edge layer, aggregation layer, core layer) may be 1U switches, where “1U” refers to the industry-standard size for rack-mounted switches and servers. The switches may be electrical switches, optical switches, hybrid electro-optical switches, or any combination thereof. The switches may be implemented with suitable hardware and/or software that enables the routing of signals in the appropriate domain. For example, an electrical switch may include receivers that receive and convert optical signals into electrical signals for routing within the electrical switch. A receiver of an electrical switch may include a transimpedance amplifier (TIA), a photodetector, and a controller which all serve to convert the optical signals into electrical signals. Each electrical switch may further include transmitters that convert electrical signals routed within the electrical switch into optical signals for output to another switch (optical or electrical) within the system. For example, a transmitter of an electrical switch may include a light source, a modulator, and a controller that controls the modulator and light source. In some embodiments, receiver/transmitter pairs may be integrated into a single transceiver. Each electrical switch may also include internal switching circuitry for routing electrical signals within the electrical switch.

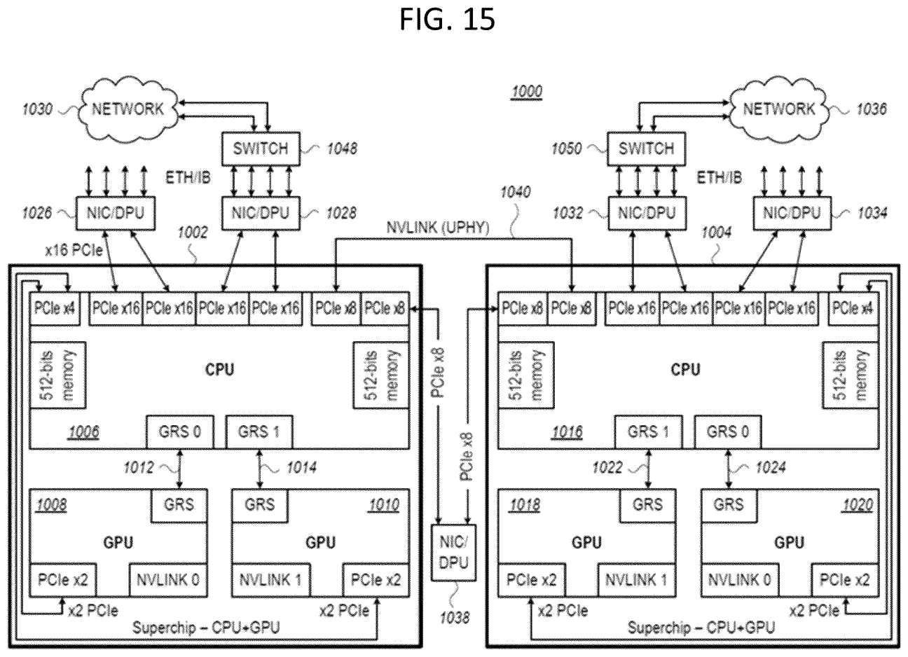

FIG. 15 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, data processing units (DPUs), quantum processing units (QPUs), a plurality of parallel processing units (PPUs), and application-specific integrated circuits (ASICs) forming a powerful and flexible architecture. QPUs configured to perform one or more operations associated with a quantum algorithm In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU that the local qubits are associated with

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 15 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 15, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

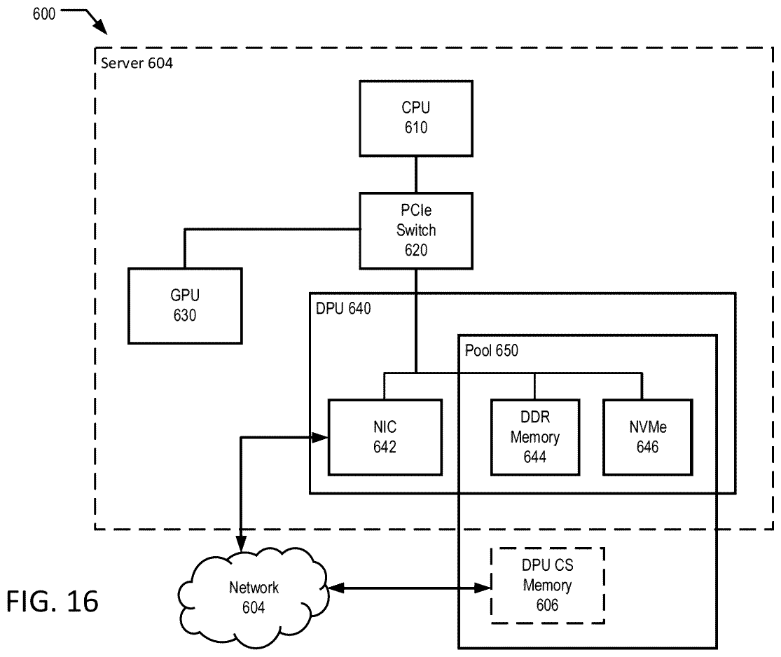

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 16, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects. The packet switches in FIG. 15 may comprise, for example, Nvidia Quantum-2 switches. The NICs/DPUs in the figure may comprise, for example, Nvidia Bluefield DPUs.

In various embodiments, any of the network devices of system 1000, e.g., any of NICs/DPUs 1026, 1028, 1032, 1034, and 1038, and/or any of switches 1048 and 1050, may include electrical components in accordance with various embodiments.

FIG. 16 illustrates an example computing environment 600 in which forward pass offloading to available memory can be performed, in accordance with at least one embodiment. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 600 may include a server 602 which may be used to perform HPC workloads, such as AI training or machine learning model training. In an embodiment, the server 602 may be an application instance or a compute node. The server 602 may include a CPU 610 associated with a switch 620, such as a peripheral component interconnect express (PCIe) switch, which may control at least some data transmission over communication paths interconnecting various components. In an embodiment, the CPU 610 may include a root complex processor.

The PCIe switch 620 may also be associated with a GPU 630 and a DPU 640, and may transmit data between at least some of the CPU 610, the GPU 630, the DPU 640, and other components. In an embodiment, the PCIe switch 620 may be associated with more than one GPU or more than one DPU. In another embodiment, the PCIe switch 620 may be located within the DPU 640. The PCIe switch 620 may manage the transfer of at least some data between the CPU 610, the GPU 630, and the DPU 640. In another embodiment, the number of GPUs associated with the PCIe switch 620 may be equal to the number of DPUs associated with the PCIe switch 620. In at least one embodiment, the server 602 may include, without limitation, any number of the CPUs 610, the PCIe switches 620, the GPUs 630, and/or the DPUs 640, in any combination. For example, in at least one embodiment, server 602 could include eight, sixteen, thirty-two, and/or more GPUs 630. In at least one embodiment, communication paths interconnecting various components, including but not limited to the CPU 610, the PCIe switch 620, the GPU 630, and the DPU 640, in FIG. 16 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

The DPU 640 may include a network interface controller (NIC) 642, a DDR memory 644, and a non-volatile memory express (NVMe) device 646. The NIC 642 may be able to interface with a network 604, which may also interface with additional NVMe devices available to the DPU 640, such as over fabric. In an embodiment, the DPU 640 may not include the NVMe device 646. In another embodiment, the NVMe device 646 may be located on the server 602 and not on the DPU 640. In yet another embodiment, the computing environment 600 may include more than one of the NVMe device 646, such as a first NVMe device in the DPU 640 and a second first NVMe device on the server 602 an associated directly with the PCIe switch 620. In an embodiment, the DPU 640 may not include the DDR memory 644 and may include a computational storage services (CSS) in place of, or in addition to, the DDR memory 644. For example, computing environment 600 may include DPU computational storage (CS) memory 606 available to the DPU 640 as part of the CSS. The network 604 may be able to interface with the DPU CS memory 606 through the NIC 642, according to any suitable interface protocol, such as remote direct memory access (RDMA) over Ethernet, InfiniBand, Fiber Channel, etc.

The total memory of the computing environment 600 available for data storage may be expanded through the use of the DPU 640 on nodes of the system. The DPU 640 may have access to a pool 650 of memory already available to the server 602, such as double data rate (DDR) memory, on-board NVMe devices, NVMe devices over fabric, and CS. The pool 650 of memory may include at least one of the DDR memory 644, NVMe device 646, and the DPU CS memory 606. The DPU 640 may also be able to access the available memory of other DPUs as part of the pool 650, and other DPUs may be able to access the available memory of DPU 640, such as the pool 650. This available memory can be accessed and utilized for data storage, without the addition of compute resources, such as compute nodes, which would be required using other solutions. The available pool 650 accessible to the DPU 640 may be provisioned for the server 602 to expand the total memory available for data storage, such as to reduce the data storage load on the CPU 610 or the GPU 630, which can instead increase the utilization of their memory for processing. For example, during training of an AI, the model states, residual states, activation functions, and checkpoints can be stored, or offloaded, on the pool 650 accessible to the DPU 640.

### Multichip-Module (MCM) Assembly

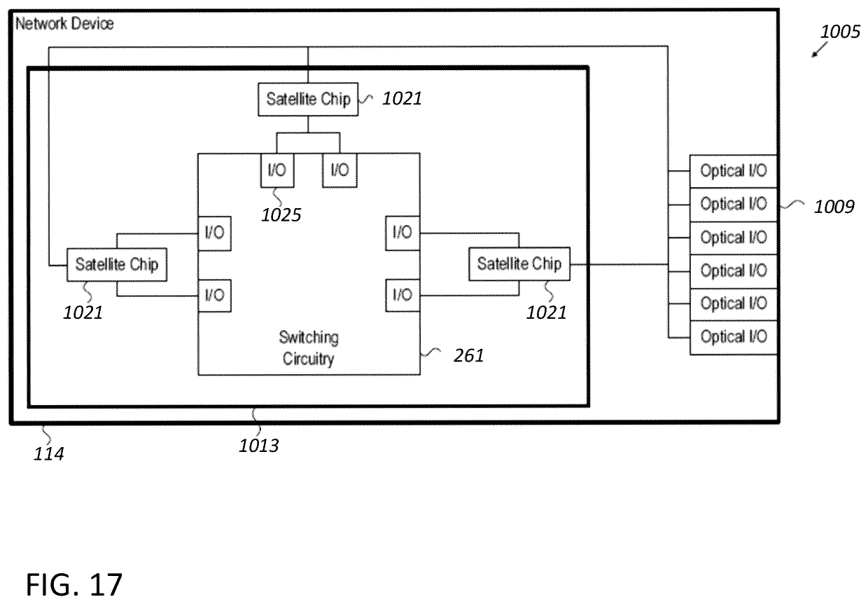

FIG. 17 is a block diagram that schematically illustrates a co-packaged Networking Device 114, in accordance with an embodiment that is disclosed herein. In some embodiments, the different chips that constitute a co-packaged Networking Device are assembled on a single substrate in what is typically called the MCM assembly 1013, or alternatively, a plurality of substrates are provided in a co-packaged Networking Device 114 that each support multiple chips thereon. The MCM assembly 1013 can include a switching circuitry embodying the computing resources 261 (embodying computing resources) surrounded by peripheral or satellite chips 1021. In some embodiments, the switching circuitry embodying the computing resources 261 and surrounding satellite chips 1021 are all mounted on a common substrate, although such a configuration is not required. The MCM assembly 1013 may be provided in a larger housing of the networking device 114, positioned behind the front panel 1005. The switching circuitry embodying the computing resources 261 may include one or more core digital Application Specific Integrated Circuits (ASICs), CPUs, GPUs, microprocessors, FPGAs, combinations thereof, and the like. The switching circuitry embodying the computing resources 261 may include a number of input ports and/or output ports. The Input/Output (I/O) ports 1025 may include electrical ports and/or optical ports. Additionally, the switching circuitry embodying the computing resources 261 may include a combination of electrical blocks and optical blocks. The electrical blocks of the switching circuitry embodying the computing resources 261 may include a number of electrical switches that are configured to route signals in an electrical domain. The optical blocks of the switching circuitry embodying the computing resources 261 may include a number of optical components that are configured to generate, detect and route signals in an optical domain. The MCM assembly 1013, in some embodiments, may concern or include multiple satellite chips 1021 that are assembled on the same substrate as the switching circuitry embodying the computing resources 261. In some embodiments, a configuration of the optical block(s) and a configuration of the electrical block(s) depends (e.g., is based on) on the number of optical ports in the I/O ports 1025.

Optical I/Os 1009, which may also be referred to as optical connectors, are placed at the front panel 1005. As mentioned above, connectivity between the MCM assembly 1013 and optical I/Os 1009 may be transferred to the front panel 1005 through optical fibers. This connection may be made directly with an optical I/O 1009 of the switching circuitry or may be made with one or more of the satellite chips 1021. The connection is often made with one or more of the satellite chips 1021 because the satellite chips 1021 may include the electro-optic converters and, possibly, the SERDES to natively support the connection. The satellite chips 1021 may include one or more of aDSP processor, driver, trans-impedance amplifier, laser, modulator, photodiode, serializer-deserializer, or the like.

Some embodiments of the present disclosure are directed to a multi-chip module (MCM) with a centrally positioned main die and a plurality of peripherally positioned MCM sockets configured to mechanically receive and electrically connect mezzanine packages, which may include co-packaged optics (CPO) packages and co-packaged copper (CPC) packages. Each mezzanine package may include a package substrate including a connector portion that is configured to engage the MCM socket and a main portion extending beyond the periphery of the MCM substrate. The main portion of the mezzanine package may be configured to receive optical devices and/or integrated circuits, such as via mezzanine sockets, to allow connections to be made between the optical devices and/or integrated circuits/RF copper cable connectors and the main die of the MCM. Due to the extension of the mezzanine package beyond the periphery of the MCM substrate, the physical size of the MCM substrate may remain small to reduce cost and avoid the previously discussed production challenges, while allowing connections to a number of optical devices and integrated circuits via the mezzanine packages, which occupy the relatively inexpensive space around the periphery of the MCM substrate. As used herein, the terms “co-packaged optic” (or “CPO”) and “co-packaged copper” (or “CPC”) may refer to an advanced heterogeneous integration of either optics and silicon or copper and silicon, in which either integration may be implemented on a single packaged substrate. The CPO may utilize pluggable optical modules that include an optical engine (OE) to convert optical signals to electrical signals and electrical signals to optical signals. The CPO may further be comprised of an optical component on a photonics die and an electrical component on an electrical die.

As used herein, a ball grid array (BGA) may be a type of surface-mount packaging used for integrated circuits. BGA packages use an array of metallic conductor balls arranged in a grid to permanently mount devices such as microprocessors on a PCB. The metallic conductor balls may then undergo the reflow process described above, wherein the metallic conductor balls may be preheated, then melted to bond the IC to a substrate to form an IC package.

As used herein, the term “flip chip (FC)” may refer to a method for interconnecting dies, such as semiconductor devices, IC chips, integrated passive devices, and microelectromechanical systems (MEMS), to external circuitry with solder bumps that have been deposited onto chip pads. The solder bumps may be deposited onto chip pads on the top side of the wafer during final wafer processing. The chip may be mounted to external circuitry (such as a circuit board or another chip or wafer) by “flipping” the chip, such that the chip's top side faces down and is positioned to allow the pads of the chip to align with matching pads on the external circuit. Solder is reflowed to complete the interconnect.

### Packaging

In the packaging of integrated circuit (IC) chips, various packaging schemes are employed, including traditional two-dimensional (2D) integrated circuit (IC) packages as well as the more recently introduced 2.5D IC and 3D IC packages. In 2D IC packages, multiple chips are mounted on a printed circuit board, where high-performance logic, lower-performance logic, memory, and analog/RF functions, and other functional elements are presented as discrete devices in separate chip packages. By contrast, in 2.5D ICs and 3D IC packages, multiple IC chips are mounted on a silicon interposer instead of a conventional package substrate. The silicon interposer, which is typically a silicon wafer, allows very small and high-density conductive traces to be formed between the multiple IC chips because the fabrication processes used to form the conductive traces are the same processes used to form the metal interconnects in the metallization layers of a silicon chip.

Compared to 2.5D IC packages and 3D IC packages, a circuit board with individually packaged chips, such as a 2D IC package, has numerous disadvantages. For example, a 2D IC package is generally larger, heavier, consumes more power, and, because the signals propagate relatively slowly across the circuit board from one chip to another, is slower than an equivalent 2.5D or 3D IC package. Furthermore, a 2D IC package has more possible points of failure, given that the soldered joints on the circuit board are more likely to fail than the electrical connections formed within an interposer. That said, troubleshooting a 2D IC package after the different chips have been mounted on the circuit board is relatively straightforward. In particular, the conductive traces carrying I/O signals between the various chips on the circuit board are easily accessible and therefore can be employed to measure specific I/O signals during troubleshooting.

By contrast, troubleshooting a 2.5D or 3D IC package is far more problematic because the I/O signals transmitted between the different chips typically are embedded in the silicon interposer and are not physically accessible. Furthermore, because 2.5D and 3D IC packages are high-bandwidth and are quite dense, typically implementations can include thousands of conductive traces routed between the different chips. One example of such an implementation is a memory bus residing in between a processor and a high-bandwidth memory chip. In such implementations, even if the traces could be physically accessed through the silicon interposer with a probe, the accurate and reliable selection of a specific conductive trace or combination of conductive traces for the purpose of troubleshooting the IC package would be very difficult, if not impossible.

In at least one embodiment, one or more parallel processor(s) 3312 incorporate circuitry optimized for graphics and video processing, including, for example, video output circuitry, and constitutes a graphics processing unit (“GPU”). In at least one embodiment, one or more parallel processor(s) 3312 incorporate circuitry optimized for general purpose processing. In at least embodiment, components of computing system 3300 may be integrated with one or more other system elements on a single integrated circuit. For example, in at least one embodiment, one or more parallel processor(s) 3312, memory hub 3305, processor(s) 3302, and I/O hub 3307 can be integrated into a SoC integrated circuit. In at least one embodiment, components of computing system 3300 can be integrated into a single package to form a system in package (“SIP”) configuration. In at least one embodiment, at least a portion of components of computing system 3300 can be integrated into a multi-chip module (“MCM”), which can be interconnected with other multi-chip modules into a modular computing system. In at least one embodiment, I/O subsystem 3311 and display devices 3310B are omitted from computing system 3300.

In the above description, an embodiment is an example or implementation of the disclosure. The various appearances of “one embodiment,” “an embodiment,” “certain embodiments,” or “some embodiments” do not necessarily all refer to the same embodiments. Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Certain embodiments of the disclosure may include features from different embodiments disclosed above, and certain embodiments may incorporate elements from other embodiments disclosed above. The disclosure of elements of the disclosure in the context of a specific embodiment is not to be taken as limiting their use in the specific embodiment alone. Furthermore, it is to be understood that the disclosure can be carried out or practiced in various ways and that the disclosure can be implemented in certain embodiments other than the ones outlined in the description above.

The disclosure is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the disclosure belongs, unless otherwise defined. While the disclosure has been described with respect to a limited number of embodiments, these should not be construed as limitations on the scope of the disclosure, but rather as exemplifications of some of the preferred embodiments. Other possible variations, modifications, and applications are also within the scope of the disclosure. Accordingly, the scope of the disclosure should not be limited by what has thus far been described, but by the appended claims and their legal equivalents.

1. A cable tray assembly comprising:
a plurality of cable pathways, wherein each of the plurality of cable pathways route a cable around one or more curves between a first connection point of a plurality of first connection points and a second connection point of a plurality of second connection points;
wherein each of the first connection points accommodates one cable and the plurality of first connection points are spaced apart from one another.

2. The cable tray assembly of claim 1, wherein each of the plurality of cable pathways comprises a different number of curves.

3. The cable tray assembly of claim 1, wherein the plurality of cable pathways define different length cable pathways that accommodate cables having an at least substantially identical length.

4. The cable tray assembly of claim 1, wherein at least one cable pathway defines at least one loop.

5. The cable tray assembly of claim 1, wherein at least one of the plurality of cable pathways accommodates a plurality of cables.

6. The cable tray assembly of claim 1, wherein the plurality of first connection points comprises a first subset of connection points and a second subset of connection points, and wherein the first subset of connection points are arranged perpendicular to the second subset of connection points.

7. A Co-Packaged Optics (CPO) switch comprising:
a plurality of computing resources mounted on one or more substrates;
a plurality of cable trays according to claim 1, wherein the plurality of cable trays are mounted on the one or more substrates;
a plurality of fibers connecting the plurality of computing resources with a plurality of connectors, wherein the plurality of fibers are routed within the plurality of cable pathways of the cable trays.

8. The CPO switch of claim 7, wherein the plurality of connectors are arranged in a planar array.

9. The CPO switch of claim 8, wherein the plurality of connectors are offset from the plurality of cable trays.

10. The CPO switch of claim 8, wherein the plurality of fibers connect to each of the computing resources at connection points arranged around a perimeter of each of the computing resources.

11. The CPO switch of claim 10, wherein each of the computing resources is rectangular, and at least one connection point is located on each side of the perimeter of each of the computing resources.

12. The CPO switch of claim 7, wherein the plurality of fibers have an identical length.

13. A cable tray comprising:
at least one first cable pathway extending between an open first end and a first circuit exit of a plurality of circuit exits;
at least one second cable pathway extending between the open first end and a second circuit exit of the plurality of circuit exits, wherein the second circuit exit extends out of the cable tray in a direction different from the first circuit exit.

14. The cable tray of claim 13, further comprises a removeable cover.

15. The cable tray of claim 13, wherein the at least one first cable pathway accommodates a plurality of cables.

16. The cable tray of claim 13, wherein the second circuit exit is arranged perpendicular to the first circuit exit.

17. The cable tray of claim 13, wherein the at least one first cable pathway is a different length than the at least one second cable pathway and wherein each of the first cable pathway and the second cable pathway accommodate cables of at least substantially equal length.

18. The cable tray of claim 17, wherein the at least one first cable pathway defines a different number of curves than the at least one second cable pathway.

19. A cable tray assembly comprising:
a first cable tray and a second cable tray, configured according to claim 13;
a third cable tray comprising:
a second rigid housing defining at least one third cable pathway extending between a second open end and a third circuit exit of the plurality of circuit exits; and
wherein the first cable tray, the second cable tray, and the third cable tray collectively surround an open center; and
wherein the plurality of circuit exits from the first cable tray, the second cable tray, and the third cable tray exit into the open center.

20. The cable tray assembly of claim 19, wherein the open center is at least substantially rectangular.

21. The cable tray of claim 19, wherein all of: (a) the at least one first cable pathway, and (b) the at least one second cable pathway, and (c) the at least one third cable pathway accommodate cables of at least substantially equal length.
